(19) United States
(12) Patent Application Publication
(10) Pub. No.: US 2008/0114082 A1
(43) Pub. Date: May 15, 2008

(54) DISPERSING AGENT FOR METALLIC NANOPARTICLES IN AN ORGANIC MEDIA

(75) Inventor: Anne Katharina Danzebrink, St. Ingbert (DE)

Correspondence Address: AIR PRODUCTS AND CHEMICALS, INC.;PATENT DEPARTMENT, 7201 HAMILTON BOULEVARD, ALLENTOWN, PA, 181951501, US

(73) Assignee: AIR PRODUCTS AND CHEMICALS, INC., Allentown, PA (US)

(21) Appl. No.: 11/936,263

(22) Filed: Nov. 7, 2007

Related U.S. Application Data
(60) Provisional application No. 60/857,813, filed on Nov. 9, 2006.

(51) Int. Cl. B01F 3/08

(52) U.S. Cl. 516/33

(57) ABSTRACT

The invention describes a dispersing agent for nano-scale metal particles in organic media. When (additive) dispersion agents are employed for the preparation of layers according to the invention, the resultant optical quality of the layers (haze, transparency, colorlessness) is greatly improved, compared to dispersions of the same powder, but with different dispersion agents.

This Application claims the benefit of Provisional Application No. 60/857,813, filed on Nov. 9, 2006. The disclosure of this Application is hereby incorporated by reference.

### FIELD OF THE INVENTION

The instant invention relates to metallic nanoparticle dispersions and to such dispersions having a defined color, and coatings, films and layers obtained from such dispersions. The inventive dispersions can be used, for catalytic applications, electronic applications, production of antifungal materials, sensors, actuators, conductive coatings, among other applications.

### BACKGROUND OF THE INVENTION

Metallic nano-particles can form dispersions or mixtures that are black, brown or have a relatively dark hue. If such particles are processed to form layers, or are introduced into coating compounds, they can maintain that color and thus colored coatings are generated. For example, dispersions of silver nano-particles particles, which may be used, for example, to form antibacterial finishes or surfaces, can be relatively dark. Such darkly colored surfaces may unacceptable for aesthetic reasons.

### BRIEF SUMMARY OF THE INVENTION

The present invention solves problems with conventional dispersing agents by providing a dispersing agent, dispersions and formulated systems. The instant invention can produce dispersions by employing certain dispersion agents, which can lead to colorless, transparent, metallic (e.g., silver) nano-particle containing layers.

### DETAILED DESCRIPTION OF THE INVENTION

Bacteria, germs, or pathogens can be transmitted by contact with infected surfaces. Transmission can be reduced by providing surfaces, which have been appropriately treated with antibacterial coatings. Numerous methods to solving this problem are known, such as the incorporation of organic or Sn-containing organic anti-bacterial substances. These substances have the disadvantage that they may be washed off or degraded by light or heat influence and are, therefore, not effective over a longer period of time. Another disadvantage is that these substances can be introduced into the environment. To avoid these disadvantages inorganic silver compounds are increasingly employed. However, a disadvantage of conventional inorganic silver substances is that the silver can be leached out so that their effectiveness is gradually decreased. In addition, surfaces that have been treated with silver compounds that are exposed to sun light or perspiration may become irreversibly darkened. An increased stability against leaching can be achieved by employing silver nano-particles which may also result in a significant coloring of the surface.

The instant invention solves problems associated with conventional silver coatings by providing a method for introducing silver nano-particles into coatings so that they are colorless and display a relatively high transparency. This can be achieved by employing the inventive dispersing agent with metal nano-particles in organic solvents.

This invention also solves problems associated with conventional metallic dispersions by providing improved metallic dispersions (e.g., silver nanoparticle dispersions which can be used as an antimicrobial additive to transparent coatings or materials). The metallic particles will normally range in size from about 5 to about 50 nanometers with a mean particle size of about 25 nm and a particle size distribution of about 5 to about 400 nm (d50 volume distribution). The dispersion will normally comprise or consist essentially of about 1 to about 60 wt. % of metallic nanoparticles, about 0.01 to about 40 wt. % of at least one dispersing agent, and about 0 wt. % to about 99 wt. % of at least one solvent or organic media. Examples of suitable dispersing agents comprise at least one member selected from the group consisting of 2-[2-(2-methoxyethoxy)ethoxy]acetic acid, mixtures thereof, among others. An example of suitable a solvent or an organic media comprises iso-propoxy ethanol. Suitable solvents may also include at least one of the aliphatic or aromatic glycol ethers, esters, ketones, alcohols or other materials commonly used as solvents in coatings and inks.

In one aspect of the invention, the inventive dispersions can be employed for preparing transparent materials or coatings with low haze levels and other desirable properties. The inventive dispersions can be used for making a coating or film having a haze of about 0.1 to about 2.0 when measured in accordance with a haze-gard plus 4725 of Byk-Gardner and ASTM D/1003 standard test method for haze and luminous transmittance of transparent plastics and ASTM D/1044 standard test method for resistance of transparent plastics to surface abrasion. The coating is also normally transparent as determined by haze-gard plus 4725 of Byk-Gardner. The thickness of the coating will typically be about 1 μm to about 300 μm.

The inventive dispersion can be added to a wide range of polymeric formulations and systems. Examples of such systems include acrylics and polysiloxanes, among others. The amount of dispersion that is added to the polymeric formulation will normally range from about 10 ppm to about 80 wt. % of the formulation.

While particular emphasis has been placed upon using the inventive dispersing agents with silver particles, the inventive agents can be employed with a wide range of metallic nanoparticles. The inventive dispersing agents can be used to provide dispersions that may be used in a wide range of applications such as cosmetics, conductive coatings, among other uses.

The following examples are set forth to assist in understanding the invention and do not limit the invention described and claimed herein. Such variations of the invention, including the substitution of all equivalents now known or later developed, which would be within the purview of those skilled in the art, and changes in formulations or minor changes in experimental design, fall within the scope of the present invention.

### EXAMPLE 1

### Comparative Example

20 g Ag-Nano powder (25 nm) was mixed with 20 g Byk 9077 in a plastic mixing cup and processed into a paste in a three cylinder mixer. Then the paste was mixed with an ethanolic acrylate resin solution (1% solid silver and solid acrylate) and coated on a glass substrate to a 4 μm wet film thickness with a scraper. The layer was then cured with the aid of a UV laboratory drying device. The coated substrate was then tested with regard to the criteria, which are summarized in the Table below.

### EXAMPLE 2

20 g Ag-Nano powder were mixed with 4.3 g (2-[2-(2-methoxyethoxy)ethoxy]acetic, acid and 6.6 g of iso-propoxy ethanol in a plastic mixing cup and then processed to form a paste on the three cylinder mixer.

Subsequently, the following systems of Examples 3 and 4 were produced

### EXAMPLE 3

1% solid silver of the paste formed in Example 2 was mixed into the ethanolic acrylate system of Example 1. This mixture was spread-coated with a scraper to form a 4 μm wet film thickness on a substrate. The layer was then cured with the aid of a laboratory UV dryer.

### EXAMPLE 4

1% solid silver of the paste formed in Example 2 was mixed into an alcoholic siloxane system on a solid and spread-coated with a scraper to form a 4 μm wet film thickness on a glass substrate. The layer was cured in a cabinet dryer at 120° C., for one hour.

The coated substrates were then tested according to the criteria summarized in the Table below.

### EXAMPLE 5

20 g Ag-Nano powder were mixed with 4.3 g (2-[2-(2-methoxyethoxy)ethoxy]acetic, acid and 6.6 g iso-propoxy ethanol in a plastic mixing cup and processed to form a paste on the three cylinder mixer.

The following systems of Examples 6 and 7 were produced

### EXAMPLE 6

1% solid silver of this paste was mixed into an ethanolic acrylate system on a solid and spread-coated on a glass substrate to form a 4 μm wet film thickness layer. The layer was then cured with the aid of a laboratory UV dryer.

### EXAMPLE 7

1% solid of the paste formed in accordance with Example 5 was prepared and mixed into a siloxane-system and spread-coated to form a 4 μm wet film thickness on a glass substrate. The coating was then thermally cured at 120° C., for one hour in a cabinet dryer.

The coated substrates were then tested according to the criteria in the below table.

TABLE

| | appearance | | transmission | brightness | |
|---|---|---|---|---|---|
| Example | layer | haze | (%) | (T %) | color (%) |
| reference | / | 0.14 | 92.3 | 99.99 | 0.04 |
| Std floatglas | | | | | |
| Example 1 | strong brown | 2.85 | 75.3 | 92.61 | 6.07 |
| Comparative | | | | | |
| example | | | | | |
| Example 2 | colorless | 7.06 | 80.6 | 94.96 | 0.41 |
| Example 3 | colorless | 1.02 | 91.5 | 99.6 | 0.18 |
| Example 4 | colorless | 1.28 | 90.4 | 99.29 | 0.14 |
| Example 5 | colorless | 0.83 | 91.4 | 99.7 | 0.04 |

The comparative example, Example 1, had a particle size of d90=192 nm. For Examples 2-5, the particles in dispersion had a particle size of d90 (=90% of all particles being smaller than) 254 nm.

The following items of equipment were employed in accordance with conventional methods for preparing the previously described samples and generating the data in the Table:

1) Wet film preparation: 4 μm spiral scraper TQC VF0100

2) Transmission- and haze values: haze-gard plus 4725 of BYK-Gardner

3) Color determination: spectral photo meter color-sphere

4) UV-curing: UV laboratory dryer BE 20/II of Beltron GmbH

5) Thermal curing: cabinet dryer thermicon P of Heraeus Holding GmbH

The present invention is not to be limited in scope by the specific embodiments disclosed in the examples which are intended as illustrations of a few aspects of the invention and any embodiments that are functionally equivalent are within the scope of this invention. Indeed, various modifications of the invention in addition to those shown and described herein will become apparent to those skilled in the art and are intended to fall within the scope of the appended claims.

1. A colorless nanoparticle dispersion comprising metallic nanoparticles, at least one solvent and an amount of at least one dispersing agent sufficient to disperse the metallic nanoparticles.

2. The dispersion of claim 1 wherein the metallic nanoparticles comprise silver.

3. The dispersion of claim 1 wherein the dispersing agent comprises 2-[2-(2-methoxyethoxy)ethoxy]acetic, acid.

4. A coating or film formed from the dispersion of claim 1 having a color of less than about 1.

5. The coating or film of claim 4 wherein the coating has a haze of less than about 2.0.

6. The coating or film of claim 4 wherein the coating has a light transmission of at least about 80%.

7. The coating or film of claim 4 wherein the coating has a brightness of at least about 94%.

8. The coating or film of claim 4 further comprising at least one siloxane.

9. The coating or film of claim 4 further comprising at least one acrylate.

10. A nanoparticle dispersion comprising metallic nanoparticles, an amount of 2-[2-(2-methoxyethoxy)ethoxy]acetic, acid that is sufficient to disperse the nanoparticles and at least one organic solvent.

11. The dispersion of claim 10 wherein the solvent comprises iso-propoxy ethanol.

12. The dispersion of claim 10 wherein the nanoparticles comprise silver.
